(19) United States
(12) Patent Application Publication
(10) Pub. No.: US 2023/0072466 A1
(43) Pub. Date: Mar. 9, 2023

(54) RADAR SYSTEMS AND METHODS

(71) Applicant: RADOMATICS LTD., Kibutz Einat (IL)

(72) Inventors: Ehud ZOREA, Kibutz Einat (IL); Eugenie GINZBURG, Kfar Saba (IL)

(21) Appl. No.: 17/759,322

(22) PCT Filed: Jan. 20, 2021
(86) PCT No.: PCT/IL2021/050060

§ 371 Date: Jul. 22, 2022

Related U.S. Application Data
(60) Provisional application No. 62/964,352, filed on Jan. 22, 2020.

(51) Int. Cl. G01S 13/89; G01S 13/87

(52) U.S. Cl. CPC G01S 13/89; G01S 13/87

(57) ABSTRACT

Radar systems and methods utilizing multiple sub-radars, each sub-radar covering a different field of view. A radar system including: a plurality of independent sub-radars, each sub-radar, of the plurality of independent sub radars, including: a transmission antenna, including least one transmitter element, and a receiving antenna, including at least one receiver element for receiving returning signals, the transmission and receiving being directed such as to cover a three-dimensional field of view; and a processor, configured to receive updated output signals from the receiving antenna, and generate updated sub-radar data (USRD) indicative of updated characteristics of the field of view of the respective sub-radar; and a main processing unit, configured to receive USRD from the sub-radars and generate an updated composite map, indicative of characteristics of a 3D combined field of view, including at least some of the fields of view generated by the sub-radars.

### FIELD OF THE INVENTION

The present invention relates to detection and positioning systems and methods and more particularly to radar systems and methods.

### BACKGROUND OF THE INVENTION

Radar is a common device or system used for detection of targets characteristics such as targets' location and dimensions, targets' azimuth, targets' velocity/acceleration rate, targets' direction of arrival (DOA), etc., for various types of targets. Detection is done by transmitting electromagnetic signals (waves) within a specific range of wavelengths/frequencies (typically within the radio frequency (RF) such as microwave range), receiving returning (echo) signals from different targets within a field of view of the radar and processing the return signals for determining targets' characteristics.

### BRIEF DESCRIPTION OF THE DRAWINGS

The below-listed figures generally illustrate non-limiting examples of various embodiments discussed in the present document. The figures are listed as follows:

FIG. 1 (Background Art) illustrates a design for a “stacked beam radar”;

FIG. 2 illustrates a 3D image produced by radar signals' processor showing a voxels-image corresponding and representing the target(s) within the radar's field of view.

FIG. 3 illustrates a sub-radar configuration for a radar system using multiple sub-radars, according to some embodiments;

FIG. 4A illustrates a system of a plurality of sub-radars implemented in different orientations, according to some embodiments;

FIG. 4B illustrates a system of a plurality of sub-radars implemented on 3 different board substrate planes and in different orientations, according to some embodiments;

FIG. 4C illustrates a system of two sub-radars implemented with an angular offset of 90 degrees one from the other, according to some embodiments;

FIG. 5 illustrates field coverage of the sub-radar, according to some embodiments;

FIG. 6 illustrates volume coverage of the system, according to some embodiments;

FIG. 7 illustrates a united coverage field for a drone, according to some embodiments;

FIG. 8 is a flowchart, schematically illustrating process of mapping of a combined field of view, using a radar system that includes multiple independent sub-radars, according to some embodiments; and

FIG. 9 illustrates a radar chipset having an antenna-on-chip antenna setup, in which a chipset includes thereover arrays of receiver and transmitter elements, according to some embodiments.

For simplicity and clarity of illustration, elements shown in the figures are not drawn to scale.

Furthermore, reference numerals may be repeated among the figures to indicate corresponding or analogous elements. References to previously presented elements may be implied without textually citing of the drawing or description in which they appear.

### DETAILED DESCRIPTION OF SOME EMBODIMENTS

Radio frequency (RF) waves or microwave radar systems often use various scanning techniques, for scanning large a large three-dimensional (3D) volume at predefined distances ranges, typically by use of a rotatable transceiver and/or antenna, generating a plan position indication (PPI) display of the detected 3D volume being scanned, showing the radar antenna in the middle of the display (also indicating a scaled distance thereof from a ground level plane).

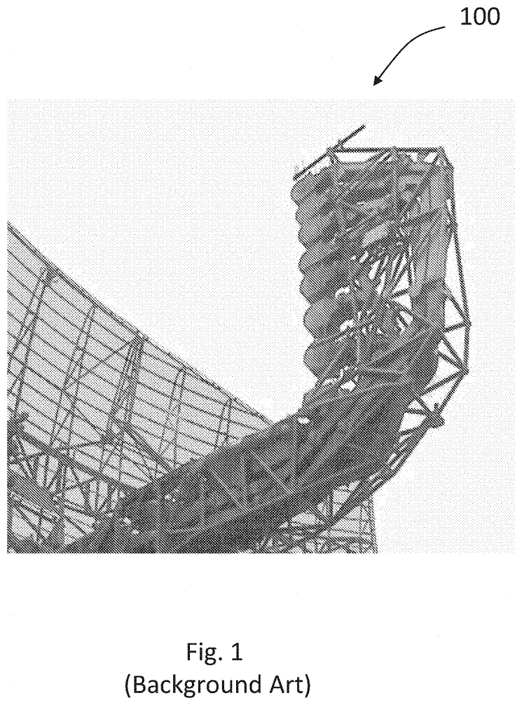

FIG. 1 (background art) illustrates a “stacked beam radar” 100, using multiple feed horns stacked in an elevated manner and a rotatable antenna, allowing thereby omnidirectional scanning.

Aspects of disclosed embodiments pertain to radar systems, each radar system including:

a plurality of independent sub-radars, each sub-radar, of the plurality of independent sub radars, may include: (i) an antenna setup including a transmission antenna, which includes least one transmitter element, for transmission of electromagnetic signals, and a receiving antenna, which includes at least one receiver element for receiving returning electromagnetic signals, the transmission and receiving antennas of the respective antenna setup being directed such as to cover a three-dimensional (3D) field of view; and (ii) a processor, configured to receive updated output signals, outputted by the receiving antenna, process the received output signals and generate and output updated sub-radar data (USRD) indicative of one or more updated characteristics of the field of view of the respective sub-radar; and

a main processing unit, configured to receive USRD from at least some of the plurality of independent sub-radars and generate an updated composite map, based on the received USRD, the composite map being indicative of one or more characteristics of a 3D combined field of view, comprising the fields of view of the at least some of the plurality of independent sub-radars.

According to some embodiments, the antenna setup of each one of the sub-radars of the radar system may be directed such as to cover a different field of view, in respect to the fields of view of the other sub-radars of the radar system view. A field of view of a specific sub-radar may overlap with a field of view of another (e.g. adjacent) sub-radar or be completely distinctive and non-overlapping therewith.

The term “field of view” used herein may refer to any 3D volume in space or in any medium that is to be monitored by the respective sub-radar, e.g. a 3D volume of space covered by both the transmission and receiving beams of the antenna setup.

According to some embodiments, the USRD, generated by the processor of a respective sub-radar, may be in the form of a voxel or pixels map including multiple voxels or pixels, a 3D points cloud data package, or in the form of a range Doppler 3D map associated with the respective field of view of the respective sub-radar. The updated composite map may respectively be in the form of a composite voxel/pixel map, 3D points cloud data package, or composite range Doppler 3D map, representing information of the combined fields of view of the at least some of the plurality of independent sub-radars. 3D points cloud of each sub-radar may include data of targets detected by the sub-radar within its field of view, data may contain range, azimuth, elevation, velocity of all or some targets within the sub-radar field of view, and is sometime referred to as a 4D or 5D cube data (X, Y, Z, Velocity, Time).

According to some embodiments, the sub-radars of the system may be configured to perform ongoing continuous or frequent (e.g. real time or near real time) operation of their respective antenna setups and processors, for continuously or frequently generating the USRD. The main processing unit may respectively be configured for ongoing continuously or frequently receiving of USRD from at least some of the sub-radars and continuously or frequently generating the corresponding updated composite map.

According to some embodiments, the combined field of view may be obtained by the overall number of sub-radars of the radar system, being used, the overall sum of all fields of view of all the sub-radars being used, the relations between 3D coverage volumes of the fields of view of the sub-radars being used, and/or one or more properties of each of the sub-radars being used. The one or more properties of each of the sub-radars may include, for example, one or more of: (a) angle of orientation of the respective sub-radar; (b) 3D volume of the field of view covered by each one of the respective sub-radars; (c) spatial resolution of the respective sub-radars' data of its detected targets (i.e. resolution of azimuth and/or elevation and/or range); (d) Doppler resolution of the respective sub-radars' data (e) dependency of spatial resolution on distance from the respective sub-radar.

According to some embodiments, the one or more characteristics of the combined field of view detectable by the main processing unit, may include for example: targets in the combined field of view and one or more target-characteristics of each of the detected targets, based on received USRD from the sub-radars; and/or environmental characteristics of the combined field of view.

According to some embodiments, the detection of targets and/or environmental characteristics may be done by using a designated detection program, using the generated updated composite map.

The designated detection program may include and/or use any one or more software algorithms and/or hardware devices.

According to some embodiments, the detection program may include all processing modules (e.g. algorithms) required for receiving the USRD from all sub-radars, obtaining/updating the updated composite map and derive additional information from that composite map such as targets properties, weather conditions and the like, e.g. in an ongoing updatable manner.

According to some embodiments, the one or more target-characteristics may include one or more of: target dimensions, target velocity, target azimuth; target acceleration rate, target 3D position/location, target electromagnetic characteristic, target type, target identity, target distance from radar system, target altitude.

The term “target” used herein may refer to any physical object, or particle of any size, dimensions, material(s) etc.

According to some embodiments, the environmental characteristics of the combined field of view comprise one or more of: weather condition in the area of the combined field of view; opacity of the area of the combined field of view.

According to some embodiments, the main processing unit may further be configured to output information indicative of one or more aspects of the generated updated composite map, such as, for example, a 3D model display of the composite map; textual information indicative of identified characteristics of the combined field of view such as detected target and their properties, weather information such as wind velocity, rain indication etc.

According to some embodiments, each sub-radar may include: the processor of the respective sub-radar; a communication unit for enabling communication with the main processing unit via one or more communication links—e.g. via electrical wires or via wireless communication; a controller for controlling direction and/or positioning of the respective sub-radar and/or of the receiver and transmitter elements of the sub-radar, for selectively controlling the field of view of the respective sub-radar.

The controller of each sub-radar may include mechanical, and/or electronical means for enabling electronically controllable steering of the beams outputted by each transmitter and/or receiver elements and/or for controlling overall directionality of the antenna setup. For example, the beam outputted by each transmitter element may be mechanically steered, by using electronically controllable mechanical means or electronically steered e.g. by using phased-array steering elements (e.g. phase modulators array).

Selectively controlling the antenna setup and/or sub-radar directionality enable selective control over one or more properties of the field of view of the respective sub-radar such as the divergence of the transmitted beams, areal positioning and location, distance from the sub-radar/system etc.

Other attributes of each sub-radar may be controllable (e.g. via the main processing unit) such as transmission and/or receiving antennas carrier frequency; transmission and/or receiving antennas pulsation properties and/or FMCW waveform, output beam characteristics of each transmitter element of the transmission antenna, relative positioning of the sub-radar in respect to adjacent sub-radars, detection duration and/or frequency (in case of using a frequently operated radar system or alternating the operation of some of the sub-radars of the radar system in respect to other sub-radars), and the like.

According to some embodiments, the main processing unit of the radar system may also be configured for analyzing the received USRD from all/some of the sub-radars for distinguishing unimportant targets (clutter targets) from important ones, using one or more cluttering techniques and programs.

The output beam characteristics may refer to any property of each of the beams outputted from each of the transmitter element such as, for example, carrier frequency of the output beam; amplitude/intensity rate of the output beam; output beam phase; output beam spatial divergence, etc.

According to some embodiments, the radar system disclosed herein may be used as stationary or mobile systems and may be modular by enabling adding and removing any number of sub-radars thereto or therefrom for adjusting the size of the radar system and/or the volume of the combined field of view to any system limitations and/or requirement.

According to some embodiments, all the sub-radars in a single radar system may be identical in configuration, illumination properties such as same wavelength/frequency band, intensity, beam divergence etc., having the same number of transmitter and receiver elements etc.

In other embodiments, one or more of the sub-radars may have different properties than those of the other sub-radars for enabling using multiple carrier frequencies, field of view volumes and distances, different spatial resolution, etc.

The main processing unit of the radar system may be located remotely from the sub-radars of the radar system, where the sub-radars and main processing unit may be configured to support long-distance wireless or wire based communication using one or more communication links (networks) using one or more: narrow and/or wide communication bandwidths, communication technologies, communication protocols, etc.

According to some embodiments, real time or near real time communication between the main processing unit and each of the sub-radars of the radar system, may be enabled by using one or more data compression and/or data packaging techniques.

Aspects of disclosed embodiments pertain to a sub-radar having an antenna setup configured according to the one or more embodiments of sub-radars as taught above and a processor for receiving receiver elements' output signals and generating corresponding USRD.

According to some embodiments, the sub-radar may also include a controller for controlling the one or more components and/or components' functionality of the antenna setup, a power source such as one or more batteries, and optionally also mechanical and/or electronical means for enabling sub-radar/antenna setup directionality control.

According to some embodiments, the sub-radar processor may be configured to generate and output 3D voxels map of characteristics of its respective field of view.

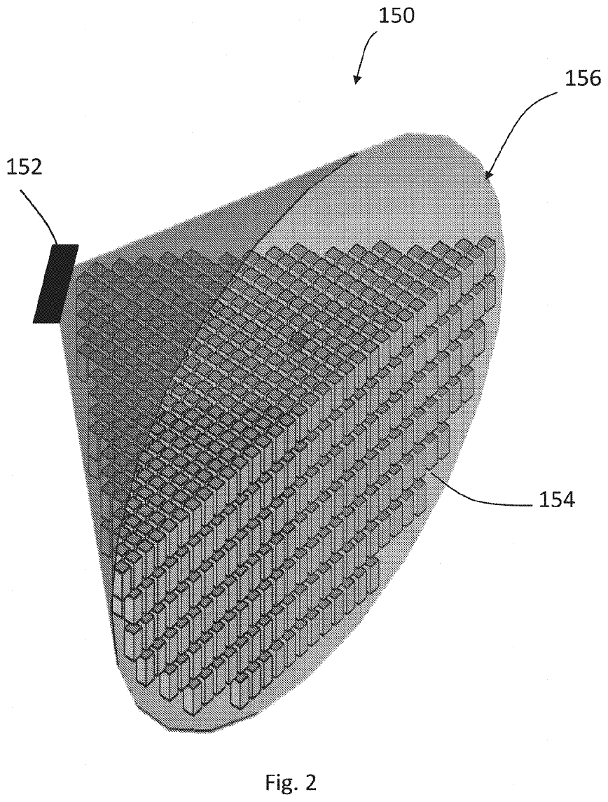

Reference is now made to FIG. 2, which schematically illustrates a 3D voxels image 150 produced by collection of individual voxels corresponding to physical characteristics detected by a respective sub-radar within its respective field of view.

The 3D voxels image 150 displays location of the sub-radar 152, voxels cloud 154, and radar search volume 156. Each voxel within the voxel cloud 154 may be represented by the dominant target present in that voxel (as there could be some targets within a single voxel having different properties such as different velocities). The voxel value can be of value different than zero or zero and if different than zero, it may be indicative of a certain target characteristic such as target velocity value and target reflected power value which can be represented by color and/or intensity.

The radar systems disclosed herein may be configured to simultaneously monitor multiple fields of view, e.g., an enlarged volume within space, while maintaining the detection quality (spatial resolution, spectral distinction etc.) of the individual sub-radars, each in its own coverage field of view.

In accordance with some embodiments of the present invention, the use of multiple sub-radars rather than a single complicated radar for covering the same volume of detection of the system with multiple sub-radars, may be advantageous for the following reasons:

Lower cost and lower complexity due to the use of multiple relatively simple low-cost sub-radar chipsets which are highly available over a single complicated chipset.

Lower synchronization complexity compared to a single radar with a large number of transmitting and receiving channels, where all transmitters and all receivers are required to be fully synchronized whereas in the multiple sub-radars system, each sub-radar transmits and receives its own signal, thus, a lower degree (if at all) of synchronization is required.

Faster detection update rates by allocating each sub-radar a different field of view, the multiple sub-radars can operate simultaneously, and as each sub-radar has a lower number of channels (compared to a single radar designed to cover the same detection volume of the comprised system), thus, an overall faster update rate of the entire (combined) field of view can be achieved (for example, there is no need to cycle between a relatively large number of transmitting channels when applying a MIMO radar waveform ie., Multiple Input Multiple Output as would often be required in the case of a single radar).

Modularity of the radar system enabling adapting it e.g. by selecting the compatible number and type of sub-radars to the specific system, based on personalized specific requirements and/or limitations of the user of the radar system.

Higher range resolution: when operating in Frequency Modulation Constant Wave (FMCW) multiple-input multiple-output (MIMO) mode, a smaller number of transmitting channel antennas can be used per sub-radar compared to that required by single MIMO radar covering the same volume. Consequently, due to the way in which a MIMO radar operates, a higher range resolution can be achieved due to the usage of a higher carrier frequency (bandwidth) allocated per each sub-radar, while maintaining the same IF (Intermediate frequency) and/or not upsetting the unambiguous Doppler measurement, as each transmitting channel antenna may be allocated more time for its operation, enabling a higher operation carrier frequency for any given IF and/or any given unambiguous Doppler required to be measured, for example when applying TDM (Time Division Multiplexing) FMCW MIMO.

Higher unambiguous Doppler measurement: the use of a lower number of transmitting channel antennas per sub-radar (as opposed to the number of transmitting channel antennas required by single radar) decreases the time required to complete transmitting channel cycles. Such decrease may lead to higher unambiguous velocity (Doppler) measurements by the system as the cycle to complete the multiple transmitters can be reduced such as when applying a TDM MIMO FMCW mode of operation.

Non-synchronized sub-radars: in accordance with some embodiments, each one of such sub-radar chipsets operates separately and independently, and thus, does not have to be synchronized with the operation of the other sub-radars, other than allocation of carrier frequency(ies), in opposed to single radar with multiple transmitting and receiving channels where all channels have to be synchronized in operation.

Polarization usage: the option to transmit via pairs of sub-radars simultaneously in the same RF frequency when the pair of sub-radar antenna setups are designed with 90-degree RF polarization in respect to one another, forming an orthogonal RF polarization which may lead to (a) higher update rates by transmitting via two sub-radars at the same time, having minimal mutual interference due to a cross polarization of 90 degrees (i.e., if a system is comprised of six sub-radars, and every pair of sub-radars are orthogonally polarized, then three sub-radars pairs can be used simultaneously, or (b) achieving target information by the use of cross polarization (each one of the sub-radar pairs which have a cross pole offset of 90 degrees receives its own echoes as well as echoes from its pairing sub-radar, when in the latter synchronization is required within each pair.

Multiple polarizations are often desired in radar operation for the detection of special targets, such as cables and the like and to cope better with multipath reflections.

A shared local oscillator (LO) signal can be used in radar receivers, where the LO signal, or a signal derived from the LO signal is mixed (e.g. via a digital or analog mixer) with the receiving RF signal to form a base band signal to be processed by the radar's signal processor, or, alternatively a radar echo signal theoretically can be sampled in the transmitted frequency with the advance of high rate analog to digital converters (ADCs).

Therefore using a single radar instead of multiple simplified sub-radars to perform the same coverage task often requires higher complexity, higher costs, possess a limited update rate, a limited RF carrier frequency, a limited velocity (via Doppler) measurements and more.

The system of the present invention is distinguishable since each of the multiple sub-radars is designed to transmit/receive electromagnetic radiation by its antenna setup, to/from a pre-defined field of view (3D volume) which is not identical to the fields of view (3D volumes) of other sub-radars antennas.

According to some embodiments, the radar system may include: (i) a plurality of independent sub-radars, each of which having a different field of view, each one of the sub-radars comprising: an antenna setup, the antenna setup including at least one transmission antenna element and at least one receiving antenna element for transmitting/receiving radar signals to/from a specific field of view (in some embodiments, the receiving and transmitting channels may share the same physical antenna), and a processor for processing the radar signals from the antenna to generate a 3D voxel map of the 3D field of view; and (ii) a main processing unit for combining the multiple voxel maps of the plurality of independent sub-radars to output a composite voxel map corresponding to a composite detection volume, wherein the antenna elements of each one of the sub-radars is set in a different angle, thus having a different volume of coverage, and wherein the composite detection volume is determined by (a) the number of the sub-radars, (b) the orientation angle of each sub-radar, (i.e., either sub-radar orientations on a single plane or on multiple planes).

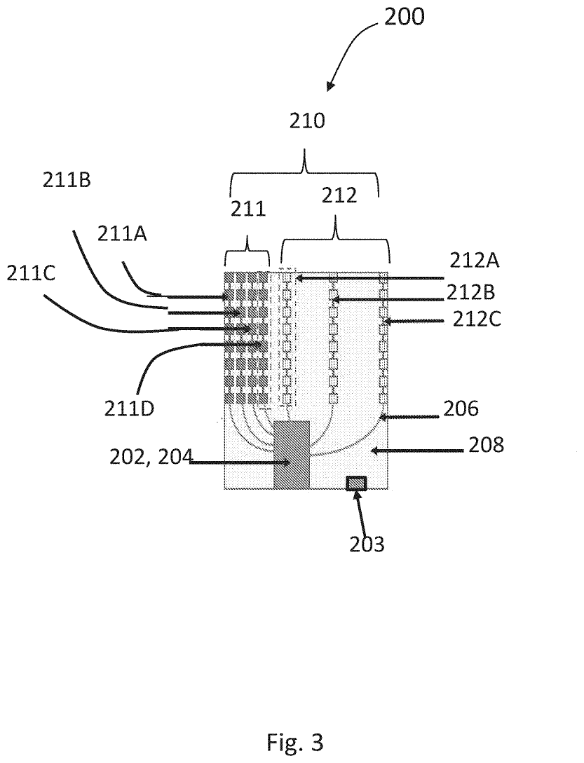

Reference is now made to FIG. 3 illustrating a sub-radar 200 design for a RF radar system, according to some embodiments. The sub-radar 200 may include a radar RF chipset 202, a processor 204 (RF chipset & processor may be implemented on a single chip), a board substrate 208, and a single antenna setup 210 formed out of receiving antenna 211 including multiple (e.g. four) receiver elements arrays: 211A, 211B, 211C and 211D and a transmission antenna 212 including multiple (e.g. three) transmitter elements arrays: 212A, 211B and 212C.

The sub-radar 200 may further include a power source 203 such as one or more batteries.

According to some embodiments, the chipset 202 may also include a controller, for controlling positioning and operation of the antenna setup; and a communication unit for enabling communication with the main processing unit of the radar system.

In accordance with some embodiments, the radar RF chipset 202 may be configured to control and processes output signals outputted by the four receiver elements arrays 211A-211D and to control transmission of output RF beams from the three transmitter elements arrays 212A-212C. Radar RF chipset 202 may process echo (returning) signals from target(s) within sub-radar's 200 field of view, and thus, generate a detection scene or a voxel cloud USRD representing characteristic(s) of the field of view of the sub-radar 200.

In accordance with some embodiments, the sub radar 200 may be designed as an ultra wideband (UWB) radar, Pulse Doppler radar, Continuous Wave (CW) radar, FMCW radar and others.

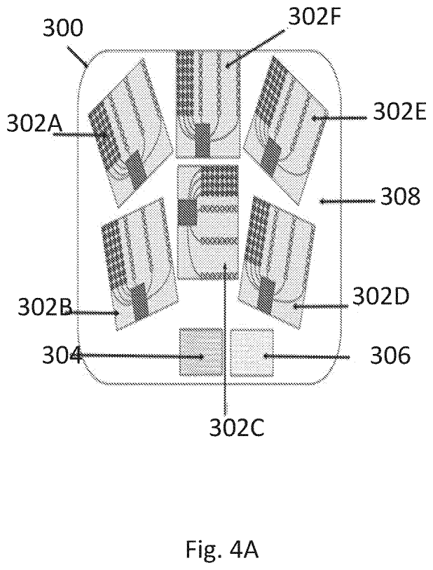

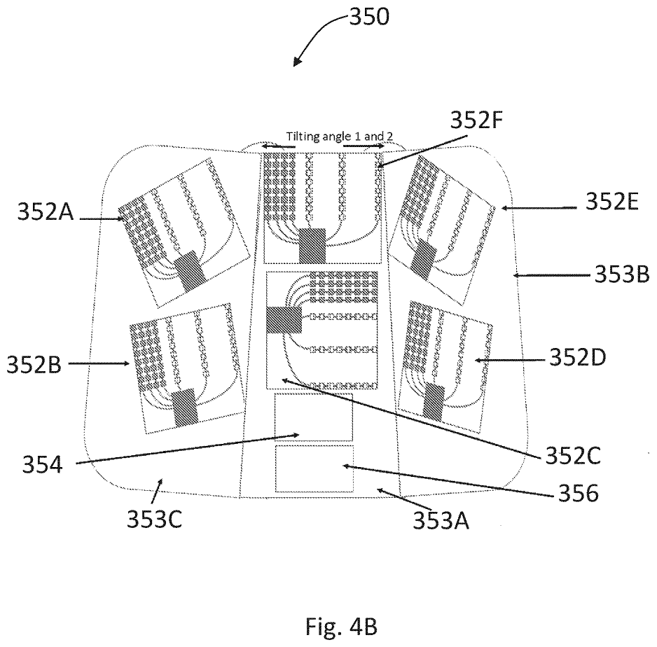

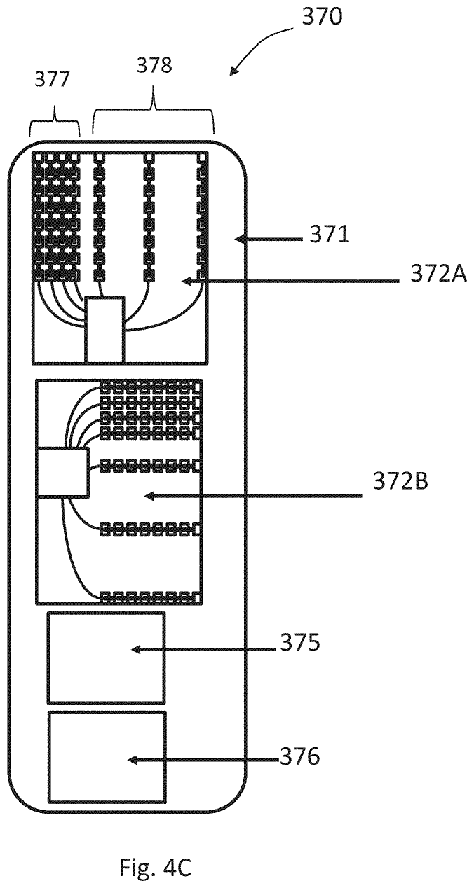

Reference is now made to FIG. 4A, illustrating a radar system 300 including a plurality of sub-radars such as sub-radars 302A, 302B, 302C, 302D and 302F positioned in different orientations, in respect to one another, to cover different fields of views, according to some embodiments.

According to some embodiments, the radar system 300 may include the plurality of sub-radars 302A-302F, a main processing unit 304, and main power supply 306. All components 302A-302F, 304 and 306 of the radar system 300 may be supported by a board substrate 308.

According to some embodiments, the main processing unit 304 may be configured to collect (receive) USRD signals or data packs, of at least some of the sub-radars 302A-302F and generate, based on the received USRD signals/data packs, an updated composite map, which is a visual data representing characteristics of a combined field of view, combining all fields of view of all the sub-radars being used for USRD collection.

According to some embodiments, one of the processors of the sub-radars 302A-302F may function as a main processing unit performing the task of combining the detection volumes of the sub-radars while the other sub-radars processors function as a slave processor for that matter and process only their own field of view.

Each one of sub-radars 302A-302F may be configured to detect targets within its field of view with no dependency on the other sub-radars aside to power allocation and/or RF band allocation and/or time allocation, etc.

According to embodiments, the sub-radars 302A-302F may transmit and receive beams/signals simultaneously, without requiring synchronization therebetween, as each transmits and receives its own signal with no dependency on its neighboring sub-radars, which may operate in different frequencies within a wider RF range. Each one of the sub-radars 302A-302F may enable processing of the data retrieved from its receiving antenna, to form a detection and/or imaging of its own field of view updated characteristics. More specifically, each one of sub-radars 302A-302F, operating on one or more of the following modes: FMCW mode, CW mode, Pulse Doppler mode, and UWB mode, can deliver detection and possibly a voxel cloud of its region of coverage.

According to some embodiments, the sub-radars 302A-302F may be configured as follows:

Sub-radar 302A may be tilted minus 30° degrees off axis (i.e., counterclockwise, with respect to Sub-radar 302F;

Sub-radar 302B is tilted minus 15° degrees off axis;

Sub-radar 302C is tilted plus 90° degrees off axis (i.e., clockwise);

Sub-radar 302D is tilted plus 15° degrees off axis;

Sub-radar 302E is tilted plus 30° degrees off axis; and

Sub-radar 302F is tilted 0° degrees off axis.

In accordance with some embodiments, sub-radars 302A-302F may be implemented either on a single board substrate 308 or on several boards combined to form a collocated system as single radar system.

The transmission/receiving antennas of sub-radars 302A-302F may be set in various angles, ie., the transmitter/receiver elements array of each one of sub-radars 302A-302F may be set in a different orientation on the main board, and thus, each one of sub-radars 302A-302F covers a different field of view (as in patch antennas, the orientation of the antenna is one of the parameters which affect the direction of the beam). In addition, sub-radars 302A-302F may have antennas of various designs and/or a different number of antenna elements to extend the detection quality within its field of view.

According to some embodiments, to avoid interference between the sub-radars, sub-radars 302A-302F may operate in different RF bands and/or different allocated transmission timings and/or delay and/or in coded transmitted signal, e.g. set and controlled by the main processing unit, further different polarity can be used as well to avoid interference between the radars and/or to enable special categorization of targets (via the use of multi polarization) or as a mean to enhance the targets RCS (Radar Cross Section) and/or as a mean to control multipath effect on radar signal processing.

In According to some embodiments, the radar system 300 may generate a relatively large combined field of view by combining the fields of view covered by all the sub-radars 302A-302F, such that the combined field of view is significantly larger than that generated by the largest of the sub-radars', e.g. at least by a factor of +10%.

The fields of view of the sub radars 302A-302F may be combined either via the main processing unit 304 or by one of the processors of the sub-radars 302A-302F, which may function also as a main processing unit. The main processing unit 304 or the processor of one of the sub-radars 302A-302F collects USRD from the processors of all the sub-radars 302A-302F, and processes the collected USRD for generating and outputting a corresponding updated composite map of the combined field of view.

According to some embodiments, the combined field of view covered by the radar system such as radar system 300 is larger than that of a single highly complex background art radar, and each one of sub-radars 302A-302F may have less analog and/or digital antenna elements than those required by a single radar designed to cover the same aggregated field of view (i.e., the united coverage of all sub-radars) with the same quality of detection, (i.e. same range accuracy and/or range resolution and/or maximum range and/or same angular accuracy and/or angular resolution and/or same Doppler accuracy and/or Doppler resolution and/or maximum or minimum Doppler of targets data detected & processed by the radar).

In some cases and spatial arrangements of the sub-radars 302A-302F (which can be modulated selectively), some of the coverage fields of view of the different sub-radars 302A-302F may overlap. Allocation of a partial field of view to each sub-radar (e.g. a partial sub-volume), may enable the radar system to process a finer spatial resolution and/or angular resolution accuracy and/or update rate can be seized within that limited volume (compared to that of a single radar which has to cover the entire field of view).

According to some embodiments, the combined field of view (e.g. overall coverage volume) can be determined (e.g. adjusted and/or modulated) by controlling/adjusting one or more of the following sub-radar properties such as one or more of:

the overall number of sub-radars being used;

the relative positioning of each sub-radar in relation to the other sub-radars;

the positioning of the entire set of sub-radars;

characteristics of the transmitted electromagnetic beams (wavelengths band, signal modulation, intensity/amplitudes, pulsation rates, FMCW mode, etc.) and also relations/differences between those characteristics between different sub-radars;

transmission and/or receiving (detection) timings.

It should be noted that sub-radars 302A-302F are not limited to have four receiver elements arrays in its receiving antenna and three transmitter elements arrays in its transmission antenna (as seen in FIGS. 2, 3A, 3B & 3C). Instead, sub-radars 302A-302F may include various configurations and types of transmitting and/or receiving antennas in each sub-radar 302A-302F.

According to some embodiments, the radar system 300 may unite the covered volumes of sub-radars 302A-302F and generate a combined volume (“covering” a volume/field means that the radar can either form a “radar image” of the united covered volume and produce a voxel cloud correlated to the radar field of view, as aforementioned, or form a classic radar detection and/or ranging of targets within that coverage volume, ie., deliver range and/or velocity and/or intensity and/or angular data of the detected targets).

Each one of sub-radars 302A-302F may be configured to detect targets within its field of view and specify (within the USRD it generates) for each one of the targets a combination set of target data, e.g. indicative of one or more properties of the respective detected target, such as, for example: velocity, angle of detection and/or range and/or intensity and or data which is sufficient to form a 3D (or 4D as often referred to within the industry—X, Y, Z, Doppler, per specific time, etc.) voxel cloud of its covered volume.

According to some embodiments, the radar system 300 may include multiple sub-radars printed on multiple boards with transmission and receiving antennas of various types, e.g., the antennas may not necessarily be identical in their properties. In accordance with other embodiments, the sub-radars may be identical (identical antennas) e.g. printed on the same board where the antennas are arranged at different angles as in FIG. 4A.

According to some embodiments, the sub-radars 302A-302F may be implemented either on the same plane as in FIG. 4A or on multiple planes that are angular to one another (i.e. forming anon-zero angle therebetween) as illustrated in FIG. 4B.

FIG. 4B illustrates a radar system 350 including a plurality of sub-radars 352A-302F implemented on three different board substrate planes 353A, 353B and 353C (planes are not parallel to each other) and in different orientations in accordance with some embodiments. The sub radars may be overlaid on the back board with their own printed board (ie. not directly printed on the back boards as illustrated in FIG. 4B)

The radar system 350 may include sub-radars 352A-352F, a main processing unit 354, and a power supply 356. The main processing unit 354 may be configured to combine the detection sub-volumes (fields of view) of the sub-radars 352A-352F and generate an output of a combined fields of view representing characteristics of a complete detection volume.

Each one of sub-radars 352A-352F, may be configured and/or positioned to detect targets within its field of view without dependence on the other sub-radars aside to power allocation and/or RF band allocation and/or time allocation. Each one of sub-radars 352A-352F can process the data retrieved from its field to form a detection and/or imaging of its own field.

More specifically, each one of the sub-radars 352A-352F may be operated on one or more of the following modes: FMCW mode, CW mode, Pulse Doppler mode, and UWB mode, can deliver detection and possibly a voxel cloud of the region within its coverage.

According to some embodiments, sub-radars 352A-352F may be configured as follows:

Sub-radar 352A is tilted minus 30° degrees off axis upon its plane (counterclockwise);

Sub-radar 352B is tilted minus 15° degrees off axis upon its plane;

Sub-radar 352C is tilted plus 90° degrees off axis upon its plane (clockwise);

Sub-radar 352D is tilted plus 15° degrees off axis upon its plane;

Sub-radar 352E is tilted plus 30° degrees off axis upon its plane; and

Sub-radar 352F is tilted 0° degrees off axis upon its plane.

In accordance with some embodiments, multiple sub-radars 352A-352F may be implemented on multiple board substrates planes in same/different orientations such as, for instance, planes 353A, 353B and 353C, where the planes 353A-353C may not be parallel to one another, e.g. tilted with some non-zero angle towards each other. Such implementation of multiple sub-radars 352A-352F on different boards enables the complete system to cover areas of detection that cannot be covered by a single plane.

In accordance with some embodiments, the angles of the board substrate planes determine the volume of coverage of that specific sub-radars incorporated upon that specific plane, and the different planes are connected electrically to the plane which possess the main processing unit and/or the power and/or the communications module for transferring digital data and/or RF signals and/or receiving power.

In accordance with some embodiments of the present invention, at least some of the sub-radars can have an option to operate in a shared Local Oscillator (LO) structure, ie., the sub-radars received RF signal is mixed down or correlated to form a signal with the same (shared) local oscillator as the other sub-radars in this mode and, by doing so, operate in a single radar mode. In accordance with some embodiments of the present invention, those sub-radars which share the same LO are referred to as “synced radars” and can receive the transmitted signal of one another in a synced manner.

FIG. 4C illustrates a radar system 370 of two sub-radars 372A-372B, a master micro controller 375 and a power supply 376 implemented on a single board substrate 371. As seen in the figure, the two sub-radars 372A-372B may be implemented at 90° degrees with respect to each other. Such topology enables two scanning angles, one for each sub-radar, and in some embodiments may be used as an altimeter sensor, ie., each sub-radar may process the data retrieved from its field to form a detection and/or imaging of its own field, and combined data from the two sub-radars 372A-372B may be used to deliver altitude data e.g. in cases in which this type of radar system 370 is carried by an aircraft, in accordance with some embodiments.

According to some embodiments, each of the sub-radars 372A-372B may have its beam steered in more than one direction e.g., steering both in azimuth and elevation (e.g. by using electromechanical steering means or via phased-array steering means) for example, if one of the transmitter elements array from the transmission antenna 378 of a sub-radar such as sub-radar 372A may be positioned offset by half a wavelength from the other two transmitter elements arrays of that same transmission antenna 377 may enable such a dual axis steering.

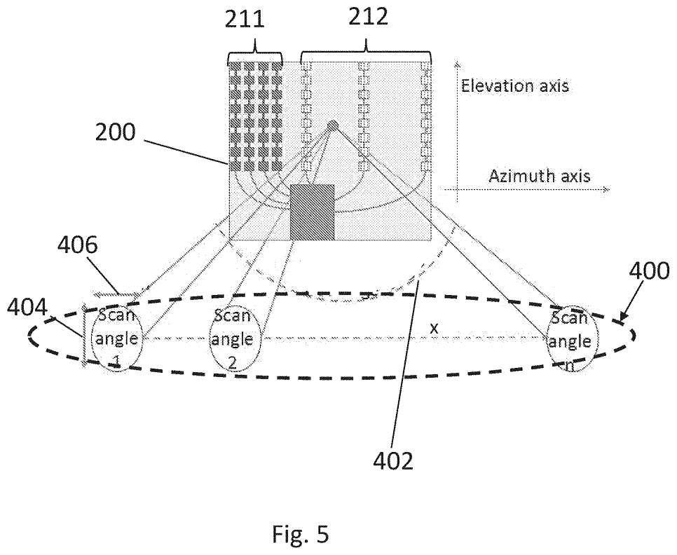

FIG. 5 illustrates a field of view 400 coverage of the sub-radar 200 in accordance with some embodiments.

The sub-radar 200 has four receiver elements arrays 211A-211D and three transmission antenna elements arrays 212A-212C. Furthermore, the sub-radar 200 has a beam width of roughly 12° degrees in elevation 404 and 8° degrees in azimuth 406 (3 dBi beam-width) when not weighted (assuming separation between each adjacent 211A-211D centers is half a wavelength of operating frequency and between each adjacent 212A-212C centers is twice the wavelength and assuming each of the 7 radiating elements 211A-211D and 212A-212C illustrated has a radiating height of roughly 4×wavelength)

Each one of four receiver elements arrays 211A-211D and of three transmitter elements arrays 212A-212C may be realized by a single antenna patch-array built out of non-limiting eight connected sub-patches where the sub-patches centers are approximately half of the center operation frequency wavelength away from each other and are matched to work in the RF operational carrier frequency of the radar.

In accordance with some embodiments, each of the output beams, outputted by the transmission antenna may be digitally steered. As seen in FIG. 5, the beam is steered along the horizontal axis “x” (illustrated as azimuth axis), while the beam-width is broadened when steered in any direction off-boresight (known antenna and Fourier properties). Also, the coverage field covers only a portion of the volume in front of the radar marked as the “coverage angle” 402 within the azimuth axis.

In accordance with some embodiments, one of the transmitter or receiver elements' (patched) arrays may be offset from the other transmitter or receiver elements' (patched) array, by a certain shift A which will enable the scanning angles to be tilted digitally in the vertical axis as well (along the azimuth axis in front of the radar marked as the “coverage angle” 402). When the beam is steered off-boresight to either side it is broadened, angular accuracy & resolution is degraded along the steering axes off-boresight.

In accordance with some embodiments, the steering of the sub-radar 200 may not be limited to a single axis such as vertical or horizontal as illustrated in FIG. 5. Instead, sub-radar 200 may be designed to steer its beam in both axes. In addition, the sub-radar 200 may not be limited to any specific number of transmitter and/or receiver elements or to a specific design of the elements and to a specific method of operation, and thus different desired angular and/or range resolution and accuracy may be maintained within the sub-fields covered by the sub-radars, as exampled by sub-radar 200 in FIG. 5.

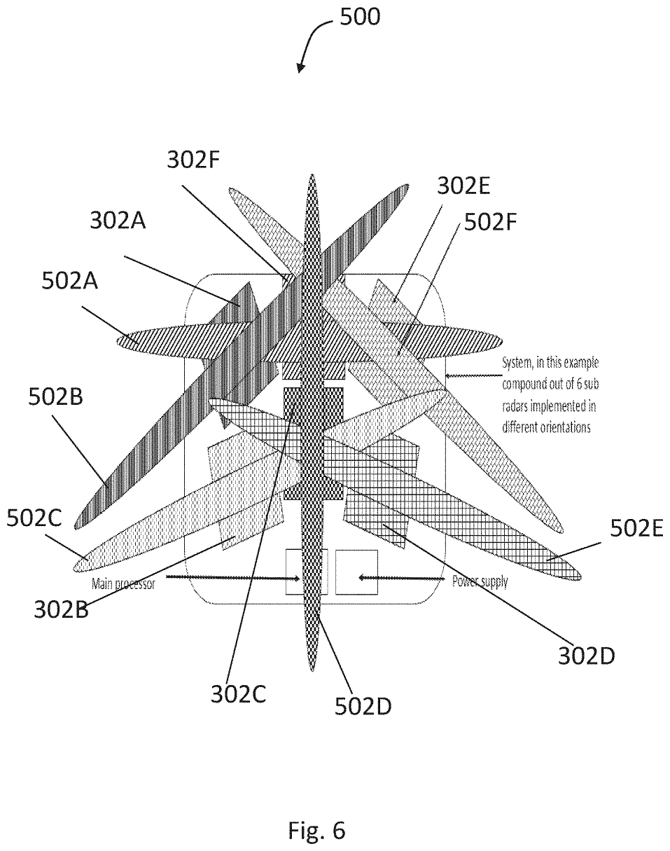

Each sub-radar 200 covers only a part of the combined field of view, whereas the entire radar system, system, can cover a substantially larger field of view as illustrated in FIG. 6.

In accordance with some embodiments, the radar chipset 202 may be a complete radar on chip device, ie., a chipset capable to transmit RF signals via at least one transmitting channel and collect RF echo signals from at least one receiving channel where the antenna is physically embodied on the chip. The chipset comprises 4 receiving channels and three transmitting channels and may have means to sample the received RF signal, from the receiving channel/channels, prior to or after shifting/mixing the received RF signal to a lower frequency.

The Chipset may have means to process the sampled data to the level of generating a 3D voxel composite map of the 3D volume of search, as described herein or to a common two-dimensional (2D) Doppler map of all of its virtual channels.

In accordance with some embodiments, some chipsets may contain only transmitting or only receiving channels—one chipset acts as a transmission antenna while the other chipset as a receiving antenna.

FIG. 6 illustrates a cut of a volume coverage 500 of the radar system 300 in accordance with some embodiments. FIG. 6 shows how each one of sub radars 302A-302F has its own antenna orientation and thus covers a different field of view (herein “volume of search”). The projection of the entire volume covered by system 300 on the radar surface (parallel to the system board plane) is shown in illustrative angles (and not in scale with regard to widths and lengths) in FIGS. 4A-4C and 6.

In accordance with some embodiments, each one of sub-radars 302A-302F processes its own data by its own processor, and either the main processing unit of the system 300 or one of the sub-radars 302A-302F designed to be the master sub-radar, combines the multiple sub-fields covered by sub-radars 302A-302F to a single detection field.

In FIG. 6 each of the ellipse shaped coverage beams 502A, 502B, 502C, 502D, 502E and 502F illustrates the coverage of each one of sub-radars 302A-202F where their antennas may cover a non identical 3D volumes. For convenience, a corresponding (same) fill pattern is used in FIG. 6 for each pair of a sub-radar and its field of view 3D coverage volume.

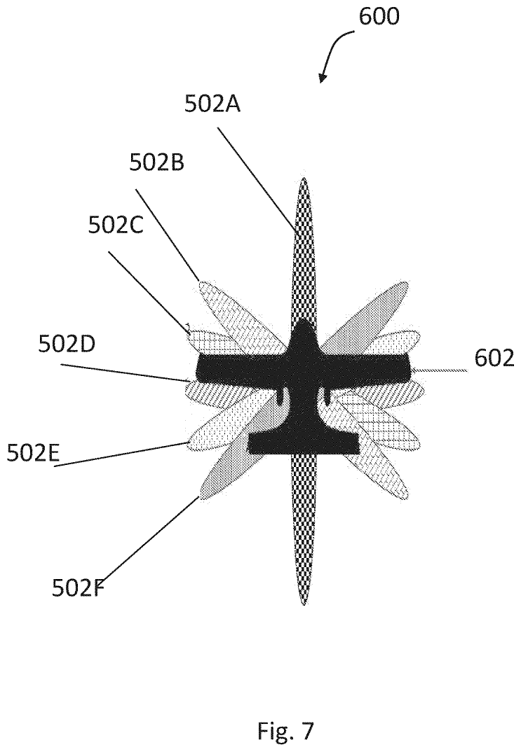

FIG. 7 illustrates a cut of a united 3D coverage volume (i.e. a combined field of view) 600 for a radar system carried by a vehicle such as a drone 602, in accordance with some embodiments. In this exemplary illustration, six fields of view 502A-502F are covered by using a radar system operating six sub-radars 2.

For illustration purposes, only the beam coverage projections which are perpendicular to the forward tip of the drone 602 are presented in FIG. 7. In accordance with some embodiments. The radar system may assist the drone 602 in navigation to destination or to avoid obstacles within the radar system's combined field of view. The radar system 300 can enable the drone to sense and/or detect and/or generate a united detection coverage, as illustrated in FIG. 7 enabling it to sense and avoid hazards during its fight, take-off and landing maneuver.

Furthermore, when radar systems 300/350/370 are positioned in such a way that their transmission antenna side has an angle of view towards the ground, radar systems 300/350/370 can supply altitude data to their hosting drone or to any other hosting flying platform via the detection of the ground altitude by sub-radars of the radar system 300/350/370. This applies as well for derivative designs of systems 300/350/370 implementing different antenna designs but sharing the same concept of an antenna fixed in multiple angles and/or planes.

In accordance with some embodiments, the radar system may be used in different applications such as in a monitoring indoor/outdoor radar, ship radar, automotive radar, robot radar, drone radar, locomotive, helicopter as a “sense and avoid” sensor or as an altitude sensor or as an “end-game” sensor, where such as a sensor enables its hosting drone to locate other drones or any other flying platform in the air and get in close proximity to them, as close as a few tens of centimeters.

As seen in FIGS. 6 and 7, coverage fields of view of the sub-radars 302A-302F may partially overlap with one another.

In accordance with some embodiments of the present invention, the process executed by the radar system 300 and sub-radars 302A-302F or the radar system 350 with sub-radars 352A-352F or the radar system 370 with sub-radars 372A-372B is compatible with radar modes of operation such as, but not limited to, Frequency Modulated Continuous Wave (FMCW), Multiple in Multiple Out (MIMO) topology, Pulse Doppler, Continuous Wave (CW) and Ultra Wide Band (UWB) radar.

According to some embodiments, in order to cover a 3D volume/field of view the radar system can either form a radar image (as the updated composite map) representing the combined field of view and produce a voxel cloud correlated to the radar field of view, as aforementioned, or form a classic radar detection and/or ranging and/or determining one or more target(s) properties such as target's direction of arrival (DOA), target's velocity, size, dimensions, distance from radar system, etc. Each sub-radar can detect targets within its field of view and for each target the sub-radar specifies a combination set of target data such as velocity and/or angle of detection and/or range and/or intensity and or data which is enough to form a 3D (or 4/5D as described, x, y, z, Doppler, per specific time) voxel cloud of its covered volume.

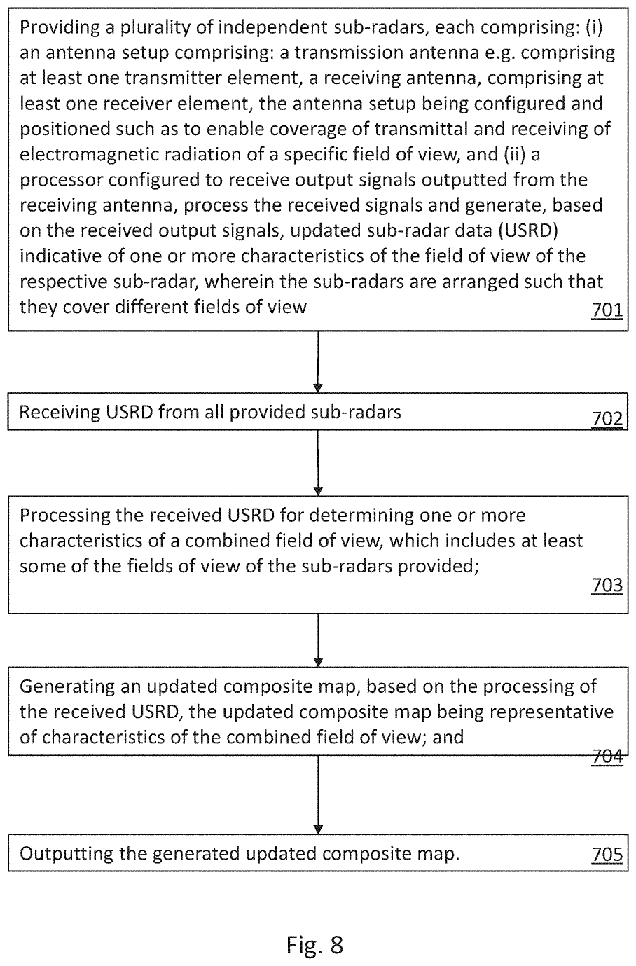

Reference is now made to FIG. 8, which shows a flowchart, schematically illustrating a process/method for radar detection using multiple sub-radars, according to some embodiments, the process may include:

providing a plurality of independent sub-radars, each comprising: (i) an antenna setup comprising: a transmission antenna comprising at least one transmitter element, a receiving antenna, comprising at least one receiver element (in some embodiment receiver and transmitter may share the same element), the antenna setup being configured and positioned such as to enable coverage of transmittal and receiving of electromagnetic radiation of a specific field of view, and (ii) a processor configured to receive output signals outputted from the receiving antenna, process the received signals and generate, based on the received output signals, USRD indicative of one or more characteristics of the field of view of the respective sub-radar, wherein the sub-radars are arranged such that they cover different fields of view 701;

receiving USRD from all provided sub-radars 702;

processing the received USRD for determining one or more characteristics of a combined field of view, which includes sat least some of the fields of view of the sub-radars provided 703;

generating an updated composite map, based on the processing of the received USRD, the updated composite map being representative of characteristics of the combined field of view 704; and

outputting the generated updated composite map 705.

According to some embodiments, the generation of the USRD and the updated composite map may be done in an ongoing frequent or continuous manner, e.g. in real time or near real time.

According to some embodiments, each of the transmitting and receiving elements of the antenna setup of one or more of the sub-radars may be in the form of a transceiver combined element, which functions both as a transmitter and receiver

The process described above may further include the step of selectively controlling one or more properties of each sub-radar being used, such as, for example, controlling:

an angle of orientation of the respective sub-radar;

3D volume of the field of view of each one of the respective sub-radar;

Doppler resolution of the respective sub-radar;

dependency of the spectral separation of the receiving and/or transmission antenna on distance from the respective sub-radar; and/or

the radar waveform of the respective sub-radar.

According to some embodiments, the main processing unit may be further configured to detect the one or more characteristics of the combined field of view, by using a designated detection program, the one or more characteristics detection such as targets in the combined field of view and one or more target-characteristics of each of the detected targets, based on received USRD from the sub-radars, and/or environmental characteristics of the combined field of view.

The detection of targets and/or environmental characteristics may be done using a designated detection program, using the generated updated composite map.

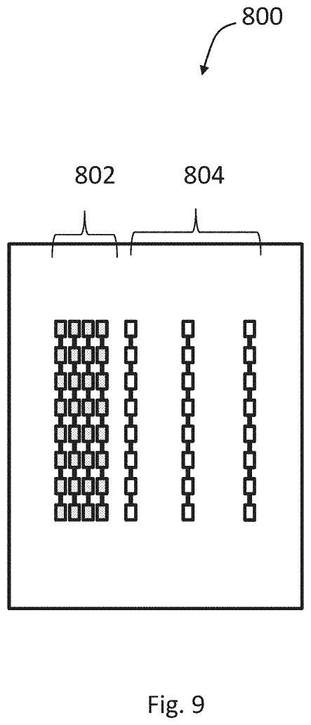

FIG. 9 illustrates a radar chipset 800 having an array of receiving elements 802 and an array of transmitting elements 804.

In accordance with some embodiments, the chipset 800 may comprise a number of receiver elements arrays 802 that is either equal to or different from the number of transmitter elements arrays 804.

In addition, in accordance with some embodiments, the receiving elements may be different from the transmitting elements, each of the transmitting elements may be different from other transmitting elements, and each of the receiving elements may be different from other receiving elements where the differences may be mainly in shape and size.

It should be noted that the process executed within the main system and the sub-radars is described herein for a general FMCW MIMO TDM mode but may include different variations depending on the applied radar (UWB, Pulse Doppler, CW or other MIMO realization such as coded chirps, chirps transmitted from several transmitter elements at the same time and others).

The FMCW mode of operation, which is well known in the radar industry, is based upon transmitting a signal with a varying frequency, e.g., a chirp signal, with a varying frequency during its transmission, and receiving the echo of that transmitted signal from targets, where after a correlation process with the frequency of the transmitted signal, the frequency of the signal received yields data which corresponds to the target distance and to its radial velocity (with respect to the radar). In accordance with some embodiments of the present invention, the first step of the detection is based on the formation of a Range Doppler map after the transmission of a set of chirps (or pulses), often referred to as “burst” (or after the transmission of a set of pulses in a Pulse Doppler radar).

If a MIMO radar is in hand having M receiving channels and antennas and N transmitting channels and antennas, then [N×M] Doppler maps may be generated from all [N*M] virtual channels in this first processing phase (all done within the sub-radar when data is received via its antenna).

In a FMCW radar, a Range Doppler map is generated by a well known two-step FFT routine, widely known in the industry, where the first FFT (or autocorrelation) is done on the received data from each chirp standalone and the 2^{nd} FFT (or autocorrelation) is done upon the result of the 1^{st} FFT (between the chirps, over the result of the 1^{st} FFT).

The result of the two-step FFT is widely known as a Range Doppler map, usually represented as a 2D plot with complex values in every location within the 2D graph (one axis is the range, other axis is the Doppler (correlated to the velocity) and the data within cells represent the target intensity having that specific Doppler value (or values) and range value with respect to the radar). This is done for every virtual channel, for example, sub-radar 302A, having 3 transmitting patches and 4 receiving patches will have 3×4=12 virtual antennas and hence, its FMCW processing can result in the generation of 12 virtual elements and 12 Range Doppler maps.

Another process is the third process having an input of [M×N] Range Doppler maps and an output of a Range Doppler map per each angular direction which can be translated in known methods to a voxel map. This process is often referred to as angle-FFT (or angle-DFT). This process combines data among different virtual antennas (i.e. different Doppler maps) or real antennas in the non-MIMO case, by using what is known as steering vectors. Specific steering vector (or matrixes for a 2D array) is generated for each angle of the desired angular view of the sub-radar (azimuth and/or elevation).

If a specific steering vector is generated for both azimuth and elevation angles, then the steering vector has a form of a steering matrix. The input of [N×M] Range Doppler maps are multiplied with the steering matrix (this procedure repeats for all angles of interest where for each angle a different steering vector (or matrix) multiplies the same previous [M×N] Range Doppler maps to generate a new Range Doppler map which is associated to a specific angle with respect to the radar, such as azimuth +22 degrees and elevation +13 degrees). At this point the output of each sub radar is a Range Doppler map for each angle (angle-FFT) and this data can be translated to a voxel cloud as it can contain data of targets in all sub-radar coverage range, distance and angle. This is repeated for all required angles of interest of the sub-radars. The next step is to associate the data of each angle-Range-Doppler map to the specific voxels within all specific angles (calculated respectfully to the sub-radar). The most dominant target for each voxel may often be presented within that voxel. For each azimuth and elevation angle a set of 3D voxels is generated from the 1^{st} range bin to the last range bin of the target whose values are calculated within the three-step transform.

### EXAMPLES

Example 1 is a radar system comprising:

a plurality of independent sub-radars, each sub-radar, of the plurality of independent sub radars, comprising:

(i) an antenna setup comprising: a transmission antenna, which comprises least one transmitter element, for transmission of electromagnetic signals, and a receiving antenna, which comprises at least one receiver element for receiving returning electromagnetic signals, the transmission and receiving antennas of the respective antenna setup being directed such as to cover a three-dimensional (3D) field of view, in some embodiment the receiving channel can share an antenna element with the transmitting channel; and

(ii) a processor, configured to receive updated output signals, outputted by the receiving antenna, process the received output signals and generate and output updated sub-radar data (USRD) indicative of one or more updated characteristics of the field of view of the respective sub-radar; and

a main processing unit, configured to receive USRD from at least some of the plurality of independent sub-radars and generate an updated composite map, based on the received USRD, the composite map being indicative of one or more characteristics of a 3D combined field of view, comprising the fields of view of the at least some of the plurality of independent sub-radars,

wherein the antenna setup of each one of the sub-radars is directed such as to cover a different field of view, in respect to the fields of view of the other sub-radars of the radar system.

In example 2, the subject matter of example 1 may include, the USRD, generated by the processor of a respective sub-radar, comprises one of: a voxel map or a range Doppler 3D map associated with the respective field of view of the respective sub-radar, and wherein the updated composite map respectively comprises a composite voxel map or composite range Doppler 3D map, of the combined fields of view of the at least some of the plurality of independent sub-radars.

In example 3, the subject matter of any one or more of examples 1 to 2 may include, wherein the sub-radars of the system are configured for ongoing continuous or frequent operation of their respective antenna setups and processors, for continuously or frequently generating USRD, and wherein the main processing unit is respectively configured for ongoing continuously or frequently receiving of USRD from at least some of the sub-radars and continuously or frequently generating the corresponding updated composite map.

In example 4, the subject matter of any one or more of examples 1 to 3 may include, wherein the combined field of view is obtained by the overall number of sub-radars of the radar system, being used, the overall sum of all fields of view of all the sub-radars being used, the relations between 3D coverage volumes of the fields of view of the sub-radars being used, and/or one or more properties of each of the sub-radars being used.

In example 5, the subject matter of example 4 may include, wherein the one or more properties of each of the sub-radars comprises one or more of: (a) angle of orientation of the respective sub-radar; (b) 3D volume of the field of view of each one of the respective sub-radar coverage zone; (c) dependency of spatial resolution on distance from the respective sub-radar; (d) frequency/wavelength separation of the receiving and/or transmission antenna of the respective sub-radar; (e) waveform configuration of the respective sub-radar.

In example 6, the subject matter of any one or more of examples 1 to 5 may include, wherein the main processing unit is configured to detect the one or more characteristics of the combined field of view, using a designated detection program, the one or more characteristics detection comprising:

detecting targets in the combined field of view and one or more target-characteristics of each of the detected targets, based on received USRD from the sub-radars;

detecting environmental characteristics of the combined field of view,

wherein the detection of targets and/or environmental characteristics is done using a designated detection program, using the generated updated composite map.

In example 7, the subject matter of example 6 may include, wherein the one or more target-characteristics comprise one or more of: target dimensions, target velocity, target azimuth, target elevation, target acceleration rate, target 3D position/location, target electromagnetic characteristic, target type, target identity, target distance from radar system, target altitude.

In example 8, the subject matter of any one or more of examples 6 to 7 may include, wherein the environmental characteristics of the combined field of view comprise one or more of: weather condition in the area of the combined field of view; opacity of the area of the combined field of view.

In example 9, the subject matter of any one or more of examples 1 to 8 may include, wherein the main processing unit is further configured to output information indicative of one or more aspects of the generated updated composite map.

In example 10, the subject matter of example 9 may include, wherein the information indicative of one or more aspects of the generated updated composite map, comprises at least one of: a 3D model of the composite map; textual information indicative of identified targets and their associated properties.

In example 11, the subject matter of any one or more of examples 1 to 10 may include, wherein each sub-radar further comprises a chipset comprising at least one of:

the processor of the respective sub-radar;

a communication unit for enabling communication with the receiver and transmitter elements of the antenna setup and with the main processing unit;

a controller for controlling direction and/or positioning of the respective sub-radar and/or of the receiver and transmitter elements of the sub-radar, and for selectively controlling the field of view of the respective sub-radar;

at least one power source.

In example 12, the subject matter of any one or more of examples 1 to 11 may include, wherein each sub-radar is further configured for selectively controlling one or more of:

sub-radar directionality and/or field of view;

sub-radar transmission and/or receiving antennas carrier frequency range;

transmission and/or receiving radar pulsation properties and/or FMCW properties and/or CW properties;

output beam characteristics of each transmitter element of the transmission antenna;

output beams mode of operation.

In example 13, the subject matter of example 12 may include, wherein the output beam characteristics comprise at least one of: carrier frequency of the output beams; amplitude, intensity and/or beam shape of the output beams; output beams phases; output beams spatial divergence.

In example 14, the subject matter of any one or more of examples 1 to 13 may include, wherein the main processing unit is located remotely from the location of the sub-radars, and wherein the main processing unit is configured for simultaneous communication with at least some of the sub-radars of the radar system for simultaneous receiving USRD therefrom.

In example 15, the subject matter of example 14 may include, wherein the main processing unit is configured to communicate with the sub-radars of the radar system via wireless or wire based communication.

In example 16, the subject matter of any one or more of examples 1 to 15 may include, wherein the radar system may further comprise a main power supply, for supplying power to the main processing unit and/or to the sub-radars.

In example 17, the subject matter of any one or more of examples 1 to 16 may include, wherein each sub-radar comprises a power source.

In example 18, the subject matter of any one or more of examples 1 to 17 may include, wherein the main processing unit comprises a communication module for communicating with all the sub-radars of the radar system via one or more communication links, and wherein each sub-radar is configured for communication with the main processing unit via the one or more communication links.

In example 19, the subject matter of f example 18 may include, wherein the main processing unit is located remotely from the sub-radars, wherein the sub-radars and the communication module of the main processing unit are configured for long-distance communication therebetween.

In example 20, the subject matter of any one or more of examples 1 to 19 may include, wherein the transmitter elements of the transmission antenna of each sub-radar are configured for transmission of electromagnetic beams within one or more carrier frequencies within the radio frequency (RF) or microwave electromagnetic spectral range.

In example 21, the subject matter of any one or more of examples 1 to 20 may include, wherein each processor of each sub-radar is further configured to process the output signals arriving from the receiving antenna for detection of one or more targets within the field of view and for determining one or more target properties associated with each detected target and to generate a USRD containing data indicative of the detected targets and their associated target properties.

In example 22, the subject matter of example 21 may include, wherein the main processing unit is further configured to analyze the received USRD of each sub-radar in order to detect all targets in the combined field of view and their associated target properties, wherein the generation of the updated composite map is carried out by representing all targets and at least some of their associated properties over a 3D voxels map.

In example 23, the subject matter of any one or more of examples 1 to 22 may include, wherein the sub-radars are being placed over at least one board substrate that has a non-flat 3D shape or a flattened planed shape.

Example 24 is a sub-radar comprising:

an antenna setup comprising: a transmission antenna, which comprises least one transmitter element, for transmission of electromagnetic signals, and a receiving antenna, which comprises at least one receiver element for receiving returning electromagnetic signals, the transmission and receiving antennas of the respective antenna setup being directed such as to cover a three-dimensional (3D) field of view, in some embodiment the receiving channel can share an antenna element with the transmitting channel;

a processor, configured to receive updated output signals, outputted by the receiving antenna, process the received output signals and generate and output updated sub-radar data (USRD) indicative of one or more updated characteristics of the field of view of the respective sub-radar;

a power source; and

a communication unit, configured at least for ongoing transmission of the USRD to at least one main processing unit, the main processing unit being configured to receive USRD from multiple sub-radars each positioned to cover a different field of view for generating a composite

In example 25, the subject matter of example 24 may include, wherein the sub-radar further comprises at least one of:

a communication unit for enabling communication with the receiver and transmitter elements of the antenna setup and with the main processing unit;

a controller for controlling direction and/or positioning of the respective sub-radar and/or of the receiver and transmitter elements of the sub-radar, and for selectively controlling the field of view of the respective sub-radar.

Example 26 is a method for radar detection comprising:

providing a plurality of independent sub-radars, each comprising: (i) an antenna setup comprising: a transmission antenna comprising at least one transmitter element, a receiving antenna, comprising at least one receiver element, the antenna setup being configured and positioned such as to enable coverage of transmittal and receiving of electromagnetic radiation of a specific field of view, and (ii) a processor configured to receive output signals outputted from the receiving antenna, process the received signals and generate, based on the received output signals, updated sub-radar data (USRD) indicative of one or more characteristics of the field of view of the respective sub-radar, wherein the sub-radars are arranged such that they cover different fields of view;

receiving USRD from all provided sub-radars;

processing the received USRD for determining one or more characteristics of a combined field of view, which includes sat least some of the fields of view of the sub-radars provided;

generating an updated composite map, based on the processing of the received USRD, the updated composite map being representative of characteristics of the combined field of view;

and

outputting the generated updated composite map.

In example 27, the subject matter of example 26 may include, wherein the generation of the USRD and the updated composite map is done in an ongoing frequent or continuous manner.

In example 28, the subject matter of example 27 may include, wherein the process is operated in near time or near real time.

In example 29, the subject matter of any one or more of examples 26 to 28 may include, wherein the method further comprises selectively controlling one or more properties of each sub-radar being used.

In example 30, the subject matter of any example 29 may include, wherein the one or more sub-radar properties comprise one or more of: (a) angle of orientation of the respective sub-radar; (b) 3D volume of the field of view of each one of the respective sub-radar; (c) spatial resolution of the respective sub-radar; (d) dependency of spatial resolution on distance from the respective sub-radar; (e) frequency/wavelength separation of the receiving and/or transmission antenna of the respective sub-radar; (f) dependency of the spectral separation of the receiving and/or transmission antenna on distance from the respective sub-radar; (g) the transmission and/or receiving distance range of the respective sub-radar.

In example 31, the subject matter of any one or more of examples 26 to 30 may include, the main processing unit is configured to detect the one or more characteristics of the combined field of view, using a designated detection program, the one or more characteristics detection comprising: detecting targets in the combined field of view and one or more target-characteristics of each of the detected targets, based on received USRD from the sub-radars; detecting environmental characteristics of the combined field of view, wherein the detection of targets and/or environmental characteristics is done using a designated detection program, using the generated updated composite map.

In example 32, the subject matter of example 31 may include, wherein the one or more target-characteristics comprise one or more of: target dimensions, target velocity, target azimuth, target elevation, target acceleration rate, target 3D position/location, target electromagnetic characteristic, target type, target identity, target distance from radar system, target altitude.

In example 33, the subject matter of any one or more of examples 31 to 32 may include, wherein the environmental characteristics of the combined field of view comprise one or more of: weather condition in the area of the combined field of view; opacity of the area of the combined field of view.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following invention and its various embodiments and/or by the following claims. For example, notwithstanding the fact that the elements of a claim are set forth below in a certain combination, it must be expressly understood that the invention includes other combinations of fewer, more or different elements, which are disclosed in above even when not initially claimed in such combinations. A teaching that two elements are combined in a claimed combination is further to be understood as also allowing for a claimed combination in which the two elements are not combined with each-other, however may be used alone or combined in other combinations. The excision of any disclosed element of the invention is explicitly contemplated as within the scope of the invention.

The words used in this specification to describe the invention and its various embodiments are to be understood not only in the sense of their commonly defined meanings, but to include by special definition in this specification structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a sub-combination or variation of a sub-combination.

Although the invention has been described in detail, nevertheless, changes and modifications, which do not depart from the teachings of the present invention, will be evident to those skilled in the art. Such changes and modifications are deemed to come within the purview of the present invention and the appended claims.

1-33. (canceled)

34. A radar system comprising:
s(i) a plurality of independent sub-radars, each sub-radar, of the plurality of independent sub radars, comprising:
an antenna setup comprising: a transmission antenna, which comprises least one transmitter element, for transmission of electromagnetic signals, and a receiving antenna, which comprises at least one receiver element for receiving returning electromagnetic signals, the transmission and receiving antennas of the respective antenna setup being directed such as to cover a three-dimensional (3D) field of view, in some embodiment the receiving channel can share an antenna element with the transmitting channel; and
a processor, configured to receive signals outputted by the receiving antenna, process the received output signals and generate and output updated sub-radar data (USRD), indicative of one or more 3D updated characteristics of the 3D field of view of the respective sub-radar; and
(ii) a main processing unit, configured to receive USRD from at least some of the plurality of independent sub-radars and generate an updated composite map, based on the received USRDs, the updated composite map being indicative of one or more characteristics of a 3D combined field of view of at least some of the plurality of independent sub-radars,
wherein the antenna setup of each one of the sub-radars is directed such as to cover a different field of view, in respect to the fields of view of the other sub-radars of the radar system.

35. The radar system of claim 34, wherein the USRD, generated by the processor of a respective sub-radar, comprises one of: a voxel map or a 3D Range Doppler map associated with the respective field of view of the respective sub-radar, and wherein the updated composite map respectively comprises a composite voxel map or composite 3D Range Doppler map, of the combined fields of view of the at least some of the plurality of independent sub-radars, wherein the Range Doppler map is such that each voxel within the coverage volume of any of the sub radars is represented by a Doppler and amplitude data of that voxel, without limiting the number of voxels within each azimuth and/or elevation angle.

36. The radar system of claim 34, wherein the sub-radars of the system are configured for ongoing continuous or frequent operation of their respective antenna setups and processors, for continuously or frequently generating USRD, and wherein the main processing unit is respectively configured for ongoing continuously or frequently receiving of USRD from at least some of the sub-radars and continuously or frequently generating the corresponding updated composite map.

37. The radar system of claim 34, wherein the combined field of view is obtained by the overall number of sub-radars of the radar system, being used, the overall sum of all fields of view of all the sub-radars being used, the relations between 3D coverage volumes of the fields of view of the sub-radars being used, and/or one or more properties of each of the sub-radars being used.

38. The radar system of claim 37, wherein the one or more properties of each of the sub-radars comprises one or more of:
(a) angle of orientation of the respective sub-radar;
(b) 3D volume of the field of view covered by each one of the respective sub-radar;
(c) spatial resolution and/or Doppler resolution achieved by the USRD of the respective sub-radar;
(d) dependency of spatial resolution on distance from the respective sub-radar;
(e) the waveform issued to the respective sub-radar.

39. The radar system of claim 34, wherein the main processing unit is configured to detect the one or more characteristics of the combined field of view, using a designated detection program, the one or more characteristics detection comprising:
(a) detecting targets in the combined field of view and one or more target-characteristics of each of the detected targets, based on received USRD from the sub-radars;
(b) detecting environmental characteristics of the combined field of view,
wherein the detection of targets and/or environmental characteristics is done using a designated detection program, using the generated updated composite map.

40. The radar system of claim 39, wherein the one or more target-characteristics comprise one or more of:
target dimensions;
target velocity;
target azimuth;
target elevation;
target acceleration rate;
target 3D position/location;
target electromagnetic characteristic;
target type;
target identity;
target distance from radar system;
target altitude;
target received amplitude;
target micro-Doppler properties.

41. The radar system of claim 39, wherein the environmental characteristics of the combined field of view comprise one or more of:
weather condition in the area of the combined field of view;
opacity of the area of the combined field of view.

42. The radar system of claim 34, wherein the main processing unit is further configured to output information indicative of one or more aspects of the generated updated composite map.

43. The radar system of claim 42, wherein the information indicative of one or more aspects of the generated updated composite map, comprises at least one of:
(a) a 3D model of the updated composite map;
(b) textual information indicative of identified targets and their associated properties.

44. The radar system of claim 34, wherein each sub-radar further comprises a chipset comprising at least one of:
the processor of the respective sub-radar;
a communication unit for enabling communication with the main processing unit;
a controller for controlling direction and/or positioning of the respective sub-radar and/or of the receiver and transmitter elements of the sub-radar, and for selectively controlling the field of view of the respective sub-radar;
at least one power source.

45. The radar system of claim 34, wherein each sub-radar is further configured for selectively controlling one or more of:
sub-radar directionality and/or field of view;
sub-radar transmission and/or receiving antennas carrier frequency;
transmission and/or receiving antennas pulsation properties;
output beam characteristics of each transmitter element of the transmission antenna;
output beams mode of operation.

46. The radar system of claim 45, wherein the output beam characteristics comprise at least one of:
Carrier frequency of the output beams;
amplitude, intensity and/or beam shape of the output beams;
output beams phases;
output beams spatial divergence.

47. The radar system of claim 34, wherein the main processing unit is located remotely from the location of the sub-radars, and wherein the main processing unit is configured for simultaneous communication with at least some of the sub-radars of the radar system for simultaneous receiving USRD therefrom.

48. The radar system of claim 47, wherein the main processing unit is configured to communicate with the sub-radars of the radar system via wireless or wire based communication.

49. The radar system of claim 34 further comprising a main power supply, for supplying power to the main processing unit and/or to the sub-radars.

50. The radar system of claim 34, wherein the main processing unit comprises a communication module for communicating with all the sub-radars of the radar system via one or more communication links, and
wherein each sub-radar is configured for communication with the main processing unit via the one or more communication links.

51. The radar system of claim 34, wherein the transmitter elements of the transmission antenna of each sub-radar are configured for transmission of electromagnetic beams within one or more carrier frequencies within the radio frequency (RF) or microwave electromagnetic spectral range.

52. The radar system of claim 34, wherein each processor of each sub-radar is further configured to process the output signals arriving from the receiving antenna for detection of one or more targets within the field of view and for determining one or more target properties associated with each detected target and to generate a USRD containing data indicative of the detected targets and their associated target properties, and wherein the main processing unit is further configured to analyze the received USRD of each sub-radar in order to detect all targets in the combined field of view and their associated target properties, wherein the generation of the updated 3D composite map is carried out by representing all targets and at least some of their associated properties over a 3D voxels map.

53. A radar-detection method comprising:
providing a plurality of independent sub-radars, each comprising: (i) an antenna setup comprising: a transmission antenna comprising at least one transmitter element, a receiving antenna, comprising at least one receiver element, the antenna setup being configured and positioned such as to enable coverage of transmittal and receiving of electromagnetic radiation of a specific three dimensional (3D) field of view, and (ii) a processor configured to receive output signals outputted from the receiving antenna, process the received signals and generate, based on the received output signals, updated sub-radar data (USRD) indicative of one or more characteristics of the 3D field of view of the respective sub-radar, wherein the sub-radars are arranged such that they cover different fields of view;
receiving USRD from all provided sub-radars;
processing the received USRD for determining one or more characteristics of a combined 3D field of view, which includes at least some of the 3D fields of view of the sub-radars provided;
generating an updated composite map, based on the processing of the received USRD, the updated composite map being representative of characteristics of the combined 3D field of view; and
outputting the generated updated composite map.
